(19) United States
(12) Patent Application Publication
(10) Pub. No.: US 2004/0240929 A1
(43) Pub. Date: Dec. 2, 2004

(54) Liquid application system

(76) Inventor: Richard Watson, Vancouver, WA (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/811,098

(22) Filed: Mar. 25, 2004

Related U.S. Application Data
(60) Provisional application No. 60/457,565, filed on Mar. 25, 2003.

(51) Int. Cl. A46B 11/02; B43M 11/06; A47L 13/22

(52) U.S. Cl. 401/286; 401/282; 401/183

(57) ABSTRACT

A liquid applicator device for applying a liquid to a target surface includes an applicator head and a reservoir. The reservoir is configured to contain the liquid to be applied to the target surface and is removably coupled to the applicator head. A liquid delivery conduit is associated with the applicator head and is in fluid communication with the reservoir. A plurality of application bristles are coupled to and extend away from the applicator head. The liquid applicator device is configured to distribute the liquid from the reservoir, through the liquid delivery conduit and to the application bristles to allow a user to apply the liquid to the target surface

This application claims benefit of U.S. Provisional Application No. 60/457,565, filed Mar. 25, 2003, which is incorporated herein by reference.

### BACKGROUND OF THE INVENTION

1. Field of the Invention

The present invention relates generally to systems for applying liquids to target surfaces.

2. Related Art

It is often desired to apply a liquid to a particular target surface with a liquid applicator, such as when applying paint with a hand-held paintbrush. Other examples of applicator brushes include basting brushes used to apply a liquid such as barbecue sauce or melted butter to food products. While conventional brushes, or “paintbrushes,” have been used for some time in such applications, conventional paintbrushes can be problematic for a number of reasons.

When using conventional paintbrushes, the liquid or paint being applied is generally contained in an independent container, such as a can or other container of liquid paint. In use, the paintbrush is dipped into the paint until a sufficient amount of paint has been deposited on and between the bristles of the paintbrush. The bristles of the paintbrush are then stroked or brushed on or over the target surface, resulting in the paint being transferred to the target surface. When the paint on the brush becomes depleted, the brush is generally dipped again into the paint container and then again brushed or stroked over remaining portions of the target surface. This process is repeated until the painter has completed the task at hand or otherwise terminates the painting process.

Due to the fact that time spent loading the brush with paint is time not spent in the actual paint application process, many painters attempt to load as much paint into the bristles of the paintbrush as possible when re-loading the brush with paint. While this can minimize the number of times the brush must be loaded with paint, many times the brush is overloaded with paint. Overloading of the brush with paint can result in paint dripping or dropping off of the paintbrush, causing undesirable spills; or too much paint may be applied to the surface, resulting in unsightly paint runs.

In addition, much of the paint loaded on or in conventional paintbrushes becomes embedded in the lowermost ends of the bristles adjacent the paintbrush handle. As it is primarily the uppermost ends, or tips, of the bristles that apply the paint to the surface, paint can be wasted by accumulating in the lower ends of the bristles near the handle. This is undesirable not only in that wasted paint results in wasted money, but also in that the brush becomes much more difficult to clean after the job is completed.

In addition, in an attempt to utilize more of the paint loaded onto or into the paintbrush, many people paint using strokes that result in more of the length of the bristles contacting the surface; that is, portions of the bristles other than the tips are used in the stroking process. This can aid in drawing out the paint accumulated near the base of the bristles. However, in many cases, it is the tips of the bristles that apply the most uniform and smooth finish to the target surface. Thus, in an attempt to use conventional brushes in the most efficient manner, many people sacrifice the finer finish provided by the bristle tips of the brush in order to minimize the number of times the brush must be re-loaded with paint.

Also, because the conventional painting process requires that the paintbrush be re-loaded with paint relatively often, most painters paint with a paintbrush in one hand and a paint container in the other. This can be disadvantageous in that the painter has no free hands with which to perform other tasks, such as cleaning up inadvertent paint spills or moving equipment that the painter is using. This can be especially problematic if the painter is painting in an elevated area, such as on a ladder or scaffolding. As both hands are needed in the conventional painting process, a potentially dangerous working environment can result in that the painter cannot securely grasp the ladder or scaffolding upon which he or she is working.

### SUMMARY OF THE INVENTION

It has been recognized that it would be advantageous to develop a liquid application system and method that can be used by a painter without the need for a separate liquid container. It has also been recognized that it would be advantageous to develop a liquid application system and method that includes a brush that is loaded with liquid without having to dip the brush into the liquid.

The invention provides a liquid applicator device for applying a liquid to a target surface, including an applicator head and a reservoir. The reservoir can be configured to contain the liquid to be applied to the target surface, and can be removably coupled to the applicator head. A liquid delivery conduit can be associated with the applicator head and can be in fluid communication with the reservoir. A plurality of application bristles can be coupled to and can extend away from the applicator head. The liquid applicator device can thus be configured to distribute the liquid from the reservoir, through the liquid delivery conduit and to the application bristles to allow a user to apply the liquid to the target surface.

In accordance with another aspect of the present invention, a liquid applicator device for applying a liquid to a target surface is provided, including an applicator head and a reservoir. The reservoir can have flexible side walls and can be configured to contain the liquid to be applied to the target surface. The reservoir can be removably engaged within the applicator head. A liquid delivery conduit can be disposed at least partially within the applicator head and can be in fluid communication with the reservoir. A flow restrictor can be operatively disposed within the liquid delivery conduit to at least partially restrict flow of the liquid through the delivery conduit. A plurality of application bristles can be coupled to and can extend away from the applicator head. The liquid applicator device is configured to deliver liquid through the liquid delivery conduit in response to pressure applied to the flexible side walls of the reservoir and to deliver the liquid to the application bristles to allow a user to apply the liquid to the target surface.

In accordance with another aspect of the present invention, a method of applying a liquid to a target surface is provided, including the steps of: obtaining a reservoir containing the liquid; coupling the reservoir to an applicator head having: a liquid delivery conduit associated therewith; and a plurality of application bristles extending therefrom; delivering the liquid from the reservoir, through the liquid delivery conduit and to the application bristles by compressing flexible sides of the reservoir; and applying the liquid to the target surface by brushing the target surface with the application bristles.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a front view of a liquid applicator device in accordance with an embodiment of the present invention;

FIG. 2 is a front, partially sectioned view of the liquid applicator device of FIG. 1;

FIG. 3A is a front, partially sectioned view of an applicator head having application bristles and a terminal delivery tube extending therefrom in accordance with an embodiment of the present invention;

FIG. 3B is a side, partially sectioned view of the applicator head of FIG. 3A;

FIG. 4A is a front, sectioned view of an applicator head in accordance with one aspect of the present invention;

FIG. 4B is a front, sectioned view of another applicator head in accordance with an aspect of the present invention;

FIG. 4C is a front, sectioned view of another applicator head in accordance with an aspect of the present invention;

FIG. 5A is a front view of an applicator head and cap in accordance with one aspect of the invention;

FIG. 5B is a front view of the applicator head and cap of FIG. 5A, with the cap engaged over the applicator head;

FIG. 5C is a side view of the applicator head and cap of FIG. 5B;

FIG. 6 is a perspective view of a reservoir filling spout in accordance with an aspect of the invention;

FIG. 7 is a perspective view of another reservoir filling spout in accordance with an aspect of the invention;

FIG. 8A is a perspective view of another liquid applicator head in accordance with an aspect of the invention; and

FIG. 8B is a perspective view of another embodiment of the liquid applicator base of FIG. 8A.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

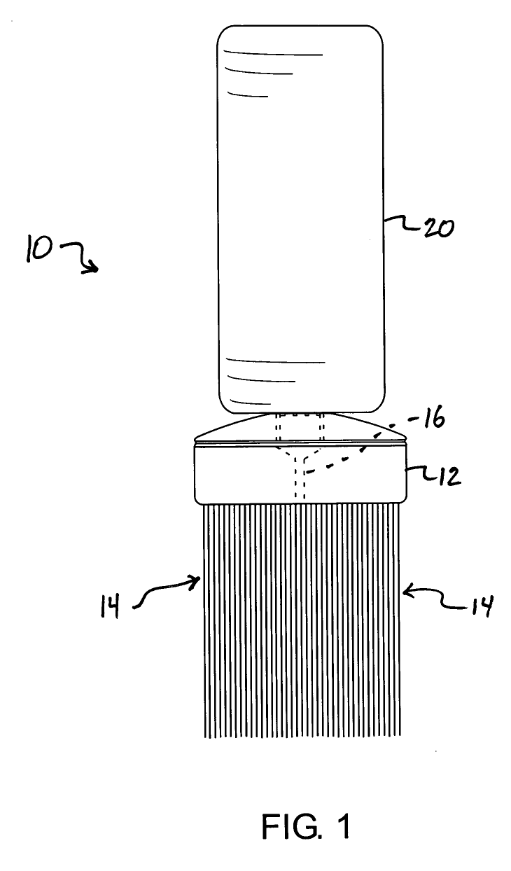

As illustrated generally at 10 in FIG. 1, the present invention provides a liquid applicator device for applying a liquid (not shown) to a target surface (not shown). The applicator device can include an applicator head 12 and a reservoir 20 which can contain the liquid to be applied to the target surface. The reservoir can be removably coupled to the applicator head in a number of manners, including via a threaded connection as shown in the drawings. A liquid delivery conduit 16 can be associated with the applicator head and can be in fluid communication with the reservoir. A plurality of application bristles 14 can be coupled to and can extend from the applicator head. The liquid applicator device can be configured to distribute the liquid from the reservoir, through the liquid delivery conduit and to the application bristles to allow a user to apply the liquid to the target surface.

The liquid applicator device can be used to apply a variety of liquids to a variety of target surfaces. While not so limited, in one aspect of the invention, the liquid can be paint, stain or varnish. In other aspects of the invention, the liquid can be a condiment, such as mustard, catsup, etc. In use, a user can obtain a reservoir, fill the reservoir with a liquid (in the case where the reservoir does not already contain liquid) and engage the reservoir within the applicator head. By squeezing or otherwise applying pressure to sides of the reservoir, the liquid is advanced from the reservoir, through the liquid delivery conduit and onto or into the application bristles. The user can then apply the liquid to a target surface by brushing or otherwise contacting the target surface with the application bristles.

The liquid applicator device can be advantageously used, for example, in painting applications, to apply paint to a target surface. After filling the reservoir with paint and engaging the reservoir within the applicator head, the paint can be substantially continuously applied to the application bristles by expelling paint through the delivery conduit to the bristles. The paint can then be applied to the target surface and replenished on the bristles without having to re-load the bristles by dipping the bristles into a separate container. When the paint supply in or on the bristles becomes depleted, the painter can simply activate or squeeze the reservoir or bottle to force more paint out of the bottle and into or onto the bristles of the brush. In this manner, a painter can perform the painting process with only hand, as the painter need not carry a separate paint container for dipping and loading the brush.

Also, by more accurately controlling the amount of paint that is supplied to the application bristles, the present invention allows more efficient use of paint. The device also allows the painter to primarily utilize the tips of the application bristles to apply the paint, leading to a superior finished product. In addition, because the brush is not overly loaded with paint, cleanup at the end of the job is much simpler, as only the tip end of the brush may need to be cleaned.

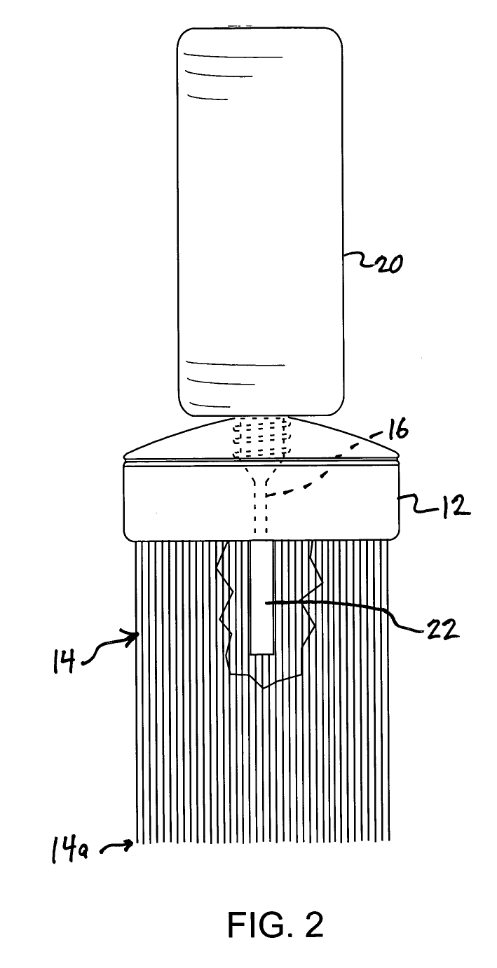

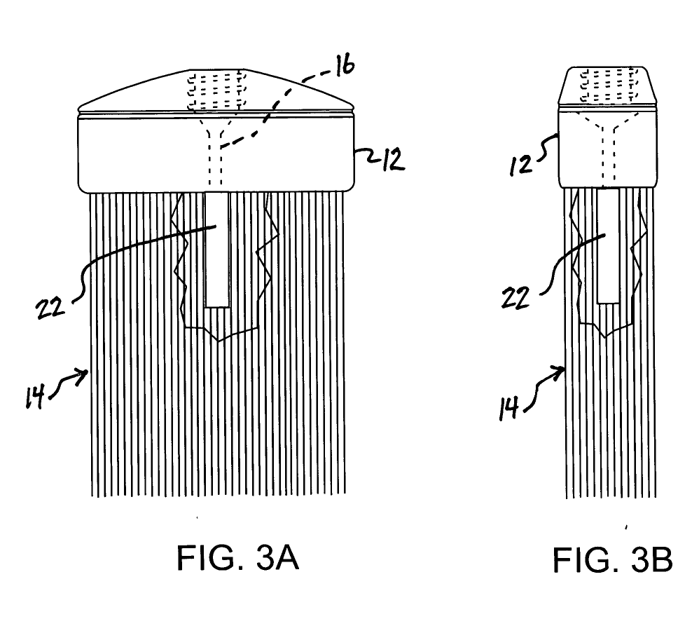

As shown in FIG. 2, in one aspect of the invention a terminal delivery tube 22 can extend from the liquid delivery conduit 16 and terminate among the application bristles 14. In this manner, paint or other liquid can be delivered from the reservoir 20 to a location within the bristles. The delivery location within the bristles can be operatively close to ends 14a of the bristles, which are generally used to apply paint or other liquid to a target surface. The terminal delivery tube can be formed of a variety of materials, and in one aspect is formed of a flexible material to facilitate flexing of the tube within the bristles to limit interference by the tube with the painting process. In addition, as shown in FIGS. 3A and 3B, the terminal delivery tube can be substantially centered within a cross section of the plurality of application bristles. In this manner, the paint or other liquid can be evenly distributed to substantially all of the application bristles to ensure even coverage of the liquid on the target surface.

The liquid reservoir 20 can include flexible side walls that can allow a user to squeeze or otherwise apply pressure to the side walls of the reservoir to expel paint from the reservoir and deliver the paint to the liquid delivery conduit 16. In other aspects, the reservoir can include substantially rigid walls and a pressurizing system or device (not shown) can be operatively coupled to the reservoir to aid in expelling paint or other liquid from the reservoir. In addition, the system can include an energized pressurizing device or system (not shown) that can utilize, for example, battery power energizing a fluid pump (not shown) to expel paint from the reservoir.

While the terminal delivery tube 22 is shown in the figures as being approximately ⅓ the overall length of the application bristles 14, the length and diameter of the delivery tube can vary according to desired applications. For example, the terminal delivery tube can be made longer so as to apply the fluid more closely to the tips of the bristles. In one embodiment, the delivery tube is very short in length, or omitted altogether, and liquid is applied to the base of the application bristles adjacent the applicator head. Also, while one delivery tube is shown in the figures, multiple tubes can be utilized to apply liquid to more than one location within or on the application bristles.

A vent or “breather” tube or valve (not shown) can also be included on or in the applicator head, liquid delivery conduit, or reservoir. The vent or breather tube can be configured to allow air to “back fill” into the reservoir as paint leaves the reservoir. This can aid in reducing a negative pressure state within the reservoir as liquid or paint is removed from the reservoir, which might otherwise result in paint being drawn back into the reservoir instead of being delivered into or onto the bristles.

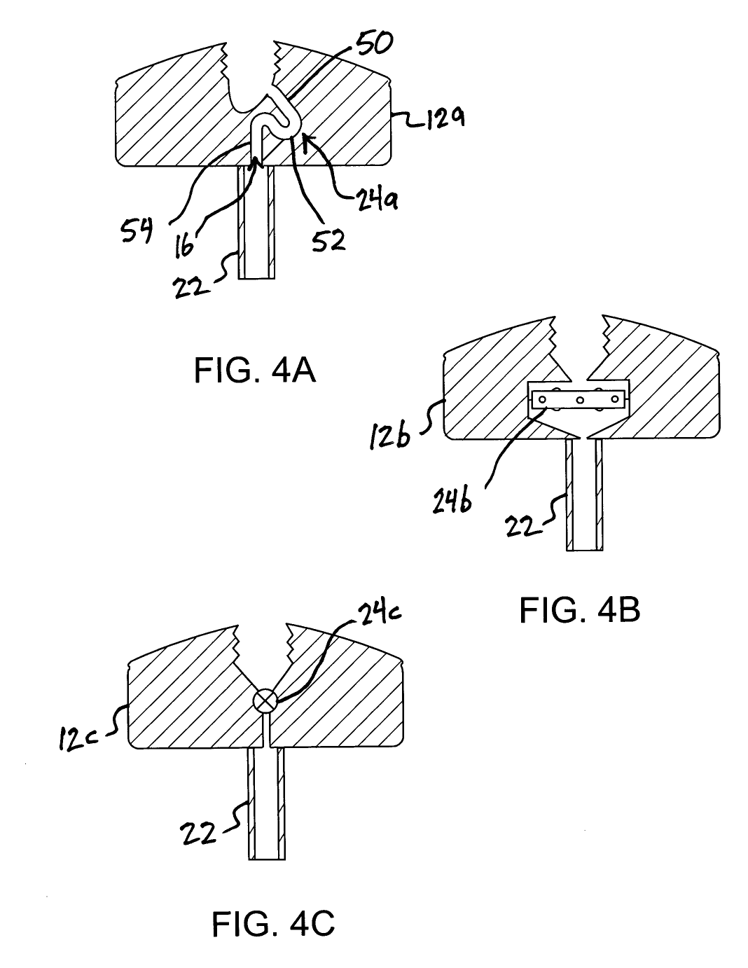

As shown in FIG. 4A, the liquid applicator device can include a flow restrictor 24a operatively disposed within the liquid delivery conduit 16 to at least partially restrict flow of liquid from the reservoir. In the aspect illustrated in FIG. 4A, the flow restrictor 24a includes a serpentine channel formed in the applicator head 12a. The serpentine channel can be used to slow or control the flow of liquid from the reservoir through the liquid delivery conduit. In one aspect of the invention, the serpentine channel includes a first, downwardly angled section 50, a second, “goose-neck” section 52, and a third, downwardly extending section 54. In this embodiment, the serpentine channel operates as a trap to at least partially limit flow of liquid through the channel in the absence of pressure applied to the liquid in the reservoir. Thus, paint or other liquid is not continuously fed to the application bristles, advantageously allowing flow of the liquid to the bristles to be controlled by the user. The serpentine channel 24a can be of a variety of configuration and can be formed with an internal size of varying diameter. For example, a channel with a relatively large diameter can be used for thicker paint, while a smaller diameter channel may perform better with thinner liquids, such as stain.

FIGS. 4B and 4C illustrate additional aspects of the flow restrictor. In FIG. 4B, the flow restrictor 24b includes a paddle wheel disposed in the liquid delivery conduit. As the paint or other liquid flows from the reservoir to the application bristles, the liquid flows over the paddle wheel causing the liquid flow rate to be reduced. By applying pressure to the reservoir or otherwise causing the liquid to flow, the liquid is forced around the paddle wheel and into the terminal delivery tube 22. In the absence of pressure applied to the liquid reservoir, the paint or other liquid is at least partially restricted from flowing past the flow control device 24b.

Shown in FIG. 4C is a general flow restrictor 24c, which can include a number of various valves, either manually controlled or system controlled. For instance, flow restrictor 24c can include a “push pin” type valve, which is opened by a user by forcing the pin to one side resulting in paint or liquid flowing past the valve. In addition, a valve controlled by a conventional turn knob can also be used and can include gradient markings (not shown) which indicate full, none, or partial opening of the valve. In addition, the flow restrictor can be a substantially straight channel with tapering walls that restrict flow of the paint or liquid. A variety of flow restrictors known to those skilled in the art can also be used, including flow restrictors than can be adjusted or tailored to the viscosity of the paint or liquid being applied.

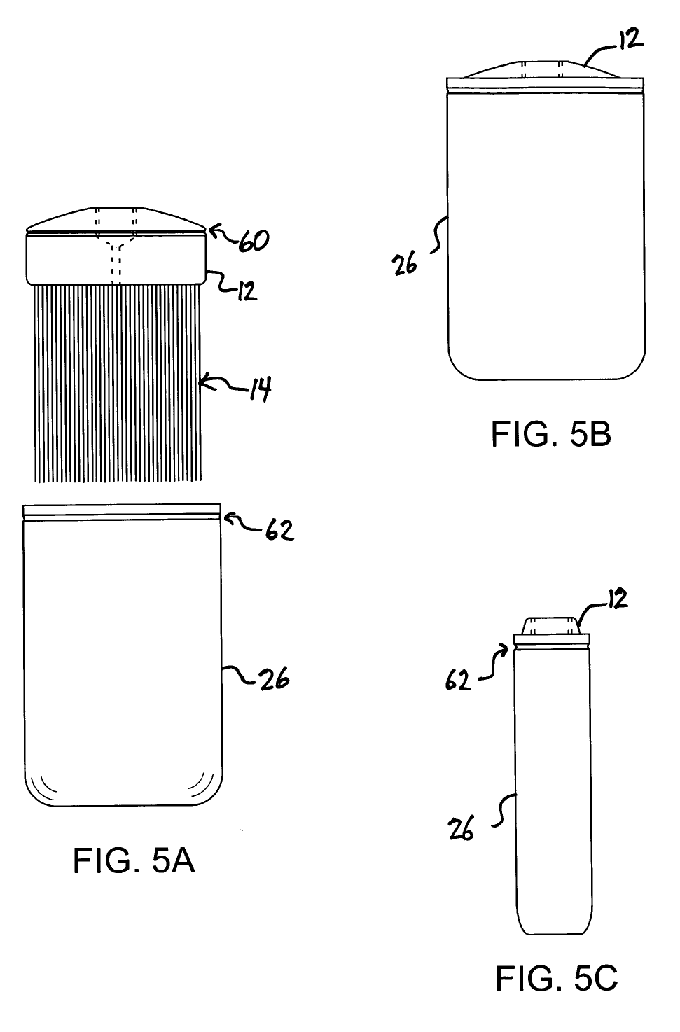

Another aspect of the invention is illustrated in FIGS. 5A through 5C. In this embodiment, a cap 26 is shown and can be configured to be attached to applicator head 12 to form a protective cover over the application bristles 14. Applicator head 12 can include securing or retaining means 60 for receiving and securing the cover 26 to the applicator head. Cap 26 can include corresponding securing or retaining means 62 for securing the cap to the applicator head. In this aspect, the cap is first placed over the bristles and then engaged with the applicator head to secure the cap or cover to the base.

The retaining or securing means 60, 62 can take a variety of forms. In one aspect of the invention, the applicator head 12 includes one of an indentation or a protrusion formed around at least a portion of an outer perimeter of the applicator head. The cap can also have one of an indentation or a protrusion formed around at least a portion of an inner perimeter of the cap. Thus, the cap can be engaged over the bristles and secured about the applicator head to form a seal about the bristles.

The seal can serve to limit drying of liquid on the bristles. In this manner, a user of the applicator device can store the device with liquid, for instance, paint, existing “wet” on the application bristles. The device can then be stored for some time without drying of the paint on the bristles. When the user is ready to resume painting, the cap can be removed and painting begun anew. This feature is advantageous in that cleaning of the applicator between painting sessions is not necessary, saving considerable time and labor for the painter. In addition, the cap can be used in a temporary manner to enable a painter to cap the applicator or brush and store the capped applicator in a pocket or other location without having paint inadvertently be deposited on non-target surfaces, such as clothes, hands, furniture, etc.

The cap 26 can be formed of a substantially transparent material to enable one to view the color of the paint on the applicator or brush, for example, or to simply ascertain if the applicator or brush is clean or has paint on it. Also, in addition to the securing or retaining means 60, 62 shown, a variety of similar means known to those skilled in the art can be included, such as threaded connections, “snap” tabs, rubber grommet seals, o-rings, press-fit interface, etc.

In one aspect of the invention, each of the indentation or protrusion of the applicator head and the cap is formed around an entire perimeter of the applicator head and cap, respectively. In this manner, a substantially air-tight seal is formed between the cap and the applicator head to limit drying of the liquid on the bristles.

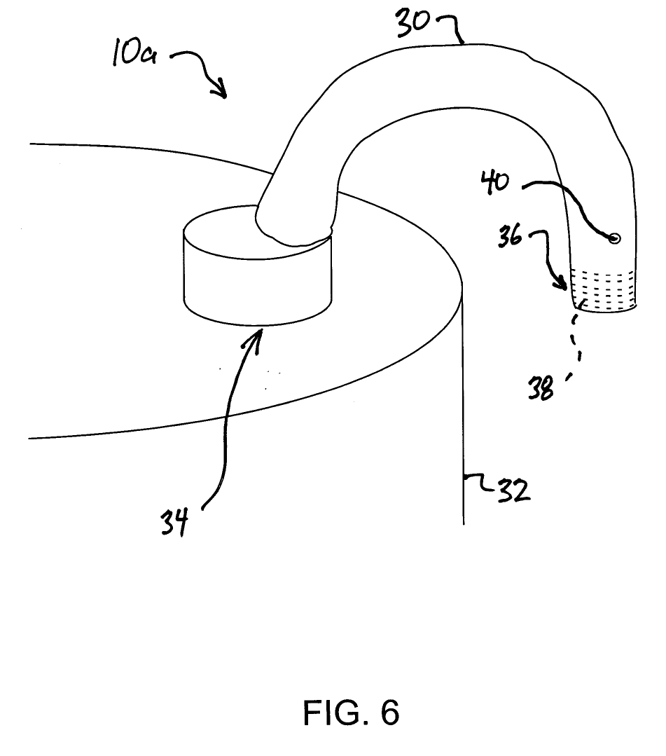

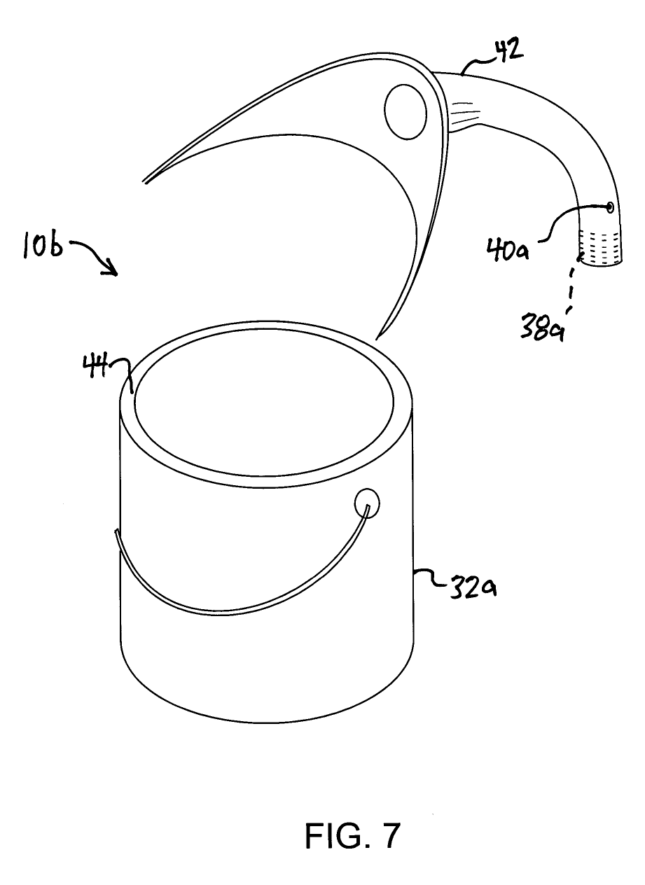

Another aspect of the present invention is shown in FIG. 6. In this embodiment, a pour spout 30 can be provided to aid in filling a liquid reservoir (not shown in FIGS. 6 and 7). The pour spout can be attached to a container 32 which holds the liquid or paint to be applied to the target surface. Container 32 can be, for example, a five gallon bucket containing paint, such as are commonly used by painters. Pour spout 30 can be coupled, via threads, snap-fit, press-fit, etc., to the container 30 at opening location 34. Opening location 34 can be an opening provided in the container, such as a threaded “bunghole” often provided on paint containers.

Once coupled or attached to container 32, a reservoir or bottle (not shown in FIG. 6) can be coupled to a terminal end 36 of the pour spout via internal threaded connection 38. Once so configured, the reservoir or bottle can be easily filled with paint by merely tipping the container 32, which causes paint to flow through the pour spout 30 and into the bottle. Because the container need only be tipped to pour the paint, the container, which may be relatively heavy, need not be lifted, saving undue exertion on the user's part and reducing the risk for injury. A vent or “breather” hole 40 can also be provided to allow the paint to more easily flow through the pour spout.

As shown in FIG. 7, a pour spout 42 in accordance with the present invention can be configured to be attached to an open container 32a to allow a reservoir or bottle (not shown) to be easily filled with paint. Container 32a can be, for example, a one gallon can of paint; a quart can of paint, or other size of container which holds a liquid or paint. The pour spout can be configured to be placed, pressed, or “tapped” into the container groove 44 to hold the pour spout secure to the container to allow tipping of the container to fill reservoirs or bottles.

In addition to the pour spouts described above, the present invention can be adapted to be used with a free-standing funnel that is connected only to the bottles or liquid reservoirs. In this manner, a funnel can be coupled to the reservoir, via threading means, etc., and the reservoir can be filled with the liquid.

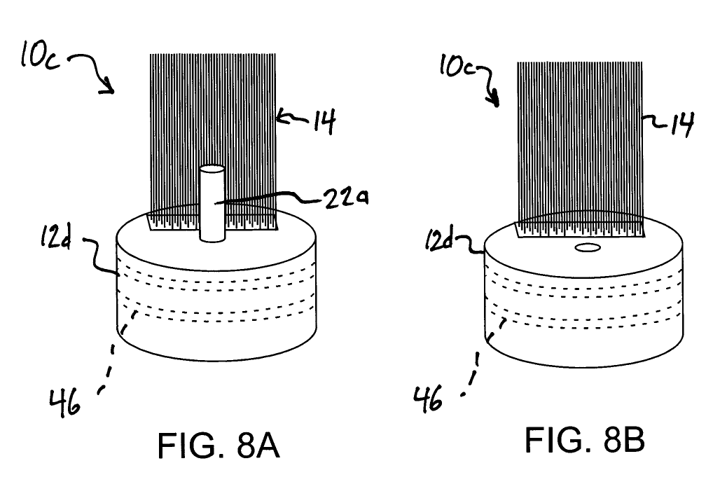

Another aspect of the present invention is shown at 10c in FIGS. 8A and 8B. In this embodiment, an applicator head 12d is provided, which can include internal threads 46. The applicator head 12d can be attached, for instance, to the tops of existing bottles (not shown) by threading the head onto top threads of the bottle. One area that can benefit from such an applicator is the area of food condiments. Condiments such as barbecue sauce, ketchup, mustard, dressing, etc., are often provided in plastic bottles with threaded tops that generally receive a conventional cover or lid. By attaching the applicator head to the top of a condiment bottle, the condiment can be forced through terminal delivery tube 22a and onto or into bristles 14. Once present on the bristles, the applicator head 12d can be used to spread the condiment on a food item by brushing bristles 14 on or over the food item. As shown in FIG. 8B, the applicator head 12d can be utilize on condiment bottles without the use of terminal delivery tube 22a, in which case the condiment or other fluid would be forced from the bottle directly to the lower portions of bristles 14.

The applicator device 10c is not limited to use with food or condiment products, but can also be used with nail polish, cosmetics, toothpaste, etc., by attaching the applicator head 12d to the bottle or tube of nail polish, toothpaste, etc., and then using application bristles 14 to apply the nail polish, toothpaste, etc. to a target surface.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

What is claimed is:

1. A liquid applicator device for applying a liquid to a target surface, comprising:
an applicator head;
a reservoir, configured to contain the liquid to be applied to the target surface, the reservoir being removably coupled to the applicator head;
a liquid delivery conduit, associated with the applicator head and being in fluid communication with the reservoir; and
a plurality of application bristles, coupled to and extending away from the applicator head;
the liquid applicator device being configured to distribute the liquid from the reservoir, through the liquid delivery conduit and to the application bristles to allow a user to apply the liquid to the target surface.

2. The device of claim 1, further including a liquid selected from the group consisting of: paint; stain; and varnish.

3. The device of claim 1, further comprising a terminal delivery tube, extending from the liquid delivery conduit and terminating among the application bristles.

4. The device of claim 3, wherein the terminal delivery tube is formed of a flexible material.

5. The device of claim 3, wherein the terminal delivery tube is substantially centered within a cross section of the plurality of application bristles.

6. The device of claim 1, wherein the reservoir includes flexible side walls configured to deform in response to pressure applied by a user to expel the liquid from the reservoir.

7. The device of claim 6, further comprising a flow restrictor, operatively disposed within the liquid delivery conduit, the flow restrictor being configured to at least partially restrict flow of liquid from the reservoir in the absence of pressure applied to the flexible side walls of the reservoir.

8. The device of claim 7, wherein the flow restrictor includes a serpentine channel formed within the applicator head, the serpentine channel being configured to restrict flow of liquid from the liquid reservoir in the absence of pressure applied to the flexible side walls of the reservoir.

9. The device of claim 8, wherein the serpentine channel includes a first, downwardly angled section, a second, gooseneck section, and a third, downwardly extending section.

10. The device of claim 7, wherein the flow restrictor includes a valve disposed within the applicator head, the valve being configured to restrict flow of liquid from the liquid reservoir in the absence of pressure applied to the flexible side walls of the reservoir.

11. The device of claim 1, wherein the applicator head includes one of an indentation or a protrusion formed around at least a portion of an outer perimeter of the applicator head, and further comprising a cap, having one of an indentation or a protrusion formed around at least a portion of an inner perimeter of the cap, the cap being configured to be engaged over the bristles and secured about the applicator head to form a seal about the bristles to limit drying of liquid on the bristles.

12. The device of claim 11, wherein each of the one of the indentation or protrusion of the applicator head and the cap is formed around an entire perimeter of the applicator head and cap, respectively, to form a substantially air-tight seal between the cap and the applicator head to limit drying of the liquid on the bristles.

13. A liquid applicator device for applying a liquid to a target surface, comprising:
an applicator head;
a reservoir, having flexible side walls and being configured to contain the liquid to be applied to the target surface, the reservoir being removably engaged within the applicator head;
a liquid delivery conduit, disposed at least partially within the applicator head and being in fluid communication with the reservoir;
a flow restrictor, operatively disposed within the liquid delivery conduit, the flow restrictor being configured to at least partially restrict flow of the liquid through the delivery conduit; and
a plurality of application bristles, coupled to and extending away from the applicator head;
the liquid applicator device being configured to deliver liquid through the liquid delivery conduit in response to pressure applied to the flexible side walls of the reservoir and to deliver the liquid to the application bristles to allow a user to apply the liquid to the target surface.

14. The device of claim 13, further including a liquid selected from the group consisting of: paint; stain; and varnish.

15. The device of claim 13, further comprising a terminal delivery tube, extending from the liquid delivery conduit and terminating among the plurality of application bristles.

16. The device of claim 15, wherein the terminal delivery tube is formed of a flexible material.

17. The device of claim 16, wherein the terminal delivery tube is substantially centered within a cross section of the plurality of application bristles.

18. The device of claim 13, wherein the flow restrictor includes a serpentine channel formed within the applicator head, the serpentine channel being configured to at least partially restrict flow of liquid from the reservoir in the absence of pressure applied to the flexible side walls of the reservoir.

19. The device of claim 18, wherein the serpentine channel includes a first, downwardly angled section, a second, gooseneck section, and a third, downwardly extending section.

20. The device of claim 13, wherein the flow restrictor includes a valve disposed within the applicator head, the valve being configured to at least partially restrict flow of liquid from the reservoir in the absence of pressure applied to the flexible side walls of the reservoir.

21. The device of claim 13, wherein the applicator head includes one of an indentation or a protrusion formed around at least a portion of an outer perimeter of the applicator head, and further comprising a cap having one of an indentation or a protrusion formed around at least a portion of an inner perimeter of the cap, the cap being configured to be engaged over the bristles and secured about the applicator head to form a seal about the bristles to limit drying of liquid on the bristles.

22. The device of claim 21, wherein each of the one of the indentation or protrusion of the applicator head and the cap is formed around an entire perimeter of the applicator head and cap, respectively, to form a substantially air-tight seal between the cap and the applicator head to limit drying of the liquid on the bristles.

23. A method of applying a liquid to a target surface, comprising the steps of:
obtaining a reservoir containing the liquid;
coupling the reservoir to an applicator head having:
a liquid delivery conduit associated therewith; and
a plurality of application bristles extending therefrom;
delivering the liquid from the reservoir, through the liquid delivery conduit and to the application bristles by compressing flexible sides of the reservoir; and
applying the liquid to the target surface by brushing the target surface with the application bristles.

24. The method of claim 23, wherein the liquid comprises a liquid selected from the group consisting of: paint; stain; and varnish.

25. The method of claim 23, wherein the step of delivering the liquid from the reservoir, through the liquid delivery conduit and to the application bristles includes the step of delivering the liquid to an area within a center of a cross section of the plurality of application bristles.

26. The method of claim 23, comprising the further step of securing a cap over the plurality of application bristles and onto the applicator head to form a seal about the bristles to limit drying of liquid on the bristles.
